(19) United States
(12) Patent Application Publication
(10) Pub. No.: US 2020/0233734 A1
(43) Pub. Date: Jul. 23, 2020

(54) WAIT-AND-SEE CANDIDATE IDENTIFICATION APPARATUS, WAIT-AND-SEE CANDIDATE IDENTIFICATION METHOD, AND COMPUTER READABLE MEDIUM

(71) Applicant: Mitsubishi Electric Corporation, Tokyo (JP)

(72) Inventors: Koichi YAMADA, Tokyo (JP); Akira HANDA, Tokyo (JP)

(73) Assignee: Mitsubishi Electric Corporation, Tokyo (JP)

(21) Appl. No.: 16/080,943

(22) PCT Filed: Aug. 19, 2016
(86) PCT No.: PCT/JP2016/074261

§ 371 Date: Aug. 29, 2018

(30) Foreign Application Priority Data
Apr. 26, 2016 (JP) 2016-088029

(51) Int. Cl. G06F 11/07

(52) U.S. Cl. CPC G06F 11/079; G06F 11/0751

(57) ABSTRACT

A constituent similarity calculation unit determines, for each attribute, whether a comparison source element that is a constituent of a monitored system in which a subject fault occurred and a comparison target element that is another constituent of the monitored system match, wherein the subject fault is a fault requiring no handling among faults that have occurred in the monitored system; and calculates a configuration similarity for the comparison target element using attributes determined to match and a contribution assigned to each attribute. A candidate identification unit identifies a wait-and-see candidate that is a candidate of a constituent requiring no handling when the subject fault has occurred, on the basis of the calculated configuration similarity.

### TECHNICAL FIELD

The present invention is related to a technique to identify a wait-and-see candidate that is a constituent of a system and for which no handling is required y when a fault occurs.

### BACKGROUND ART

In monitoring tasks, in principle, it is necessary to handle all faults that occur in a monitored system. However, in reality, there are many faults which are resolved naturally after a while and for which no handling is required, such as when a central processing unit (CPU) load temporarily increases and exceeds a threshold value.

Therefore, faults that have occurred and contents of handling are recorded, and a fault is identified for which the number and proportion of instances requiring no handling are great. Thereafter, wait-and-see handling by which only a record is kept without any handling is adopted for the identified fault. By adopting the wait-and-see handling, it is not necessary to perform tasks such as confirming logs and settings and reporting to the owner of the system for that fault. As a result, the monitoring task load can be reduced.

When a given constituent such as a server or a subsystem of the monitored system becomes a subject of the wait-and-see handling, there is a high possibility that similar constituents can also be treated as the subjects of the wait-and-see handling. When it is possible to identify many constituents as the subjects of the wait-and-see handling, the monitoring task load can be reduced a corresponding amount.

Patent Literature 1 describes calculating the similarity between configuration information of an IT system in which trouble has occurred and configuration information of trouble events accumulated in a database, and presenting handling of the trouble events together with the similarity. As a result, a large number of handling cases are narrowed down to handling cases for IT systems having configurations with high similarity.

### CITATION LIST

### Patent Literature

Patent Literature 1: WO2009/122525

### SUMMARY OF INVENTION

### Technical Problem

However, with the method of calculating the similarity described in Patent Literature 1, the fact that the influence on the similarity depends on attributes is not taken into consideration and, as such, it is not possible to appropriately calculate the similarity. Specifically, differences between the constituents cannot be appropriately determined. Consequently, when identifying a subject of the wait-and-see handling using the similarity calculated by this calculation method, there are cases in which constituents for which the wait-and-see handling should be adopted are not set as subjects of the wait-and-see handling, and cases in which constituents for which the wait-and-see handling should not be adopted are set as subjects of the wait-and-see handling.

An object of the present invention is to enable the appropriate identification of wait-and-see candidates that are candidates of constituents for which no handling is required.

### Solution to Problem

A wait-and-see candidate identification apparatus according to the present invention includes:

a constituent similarity calculation unit to determine, for each attribute, whether a comparison source element that is a constituent of a monitored system in which a subject fault occurred and a comparison target element that is another constituent of the monitored system match, the subject fault being a fault requiring no handling among faults that have occurred in the monitored system, and calculate a configuration similarity by summing values obtained by multiplying the attributes determined to match by a contribution assigned to that attribute; and

a candidate identification unit to identify, on a basis of the configuration similarity calculated by the constituent similarity calculation unit, a wait-and-see candidate that is a candidate of a constituent requiring no handling when the subject fault has occurred.

### Advantageous Effects of Invention

With this invention, whether a constituent in which a fault requiring no handling has occurred and another constituent match for each attribute is determined, and a configuration similarity is calculated by summing values obtained by multiplying the attributes determined to match by a contribution assigned to that attribute. Therefore, the similarity between the constituents can be appropriately determined and, as a result, a wait-and-see candidate can be appropriately identified.

### BRIEF DESCRIPTION OF DRAWINGS

FIG. 1 is a drawing illustrating a configuration of a monitoring system 1 according to Embodiment 1;

FIG. 2 is a drawing illustrating a configuration of a wait-and-see candidate identification apparatus 10 according to Embodiment 1;

FIG. 3 is a flowchart of monitoring processing according to Embodiment 1;

FIG. 4 is a drawing illustrating monitoring setting information 42 according to Embodiment 1;

FIG. 5 is a drawing illustrating wait-and-see setting information 43 according to Embodiment 1;

FIG. 6 is a drawing illustrating fault history information 44 according to Embodiment 1;

FIG. 7 is a drawing illustrating load information 41 according to Embodiment 1;

FIG. 8 is a flowchart of update processing according to Embodiment 1;

FIG. 9 is a flowchart of constituent similarity calculation processing according to Embodiment 1;

FIG. 10 is a drawing illustrating configuration information 45 according to Embodiment 1;

FIG. 11 is a drawing illustrating contribution information 46 according to Embodiment 1;

FIG. 12 is a drawing explaining similarity calculation processing according to Embodiment 1;

FIG. 13 is a flowchart of load similarity calculation processing according to Embodiment 1;

FIG. 14 is a drawing illustrating a configuration of the wait-and-see candidate identification apparatus 10 according to Modification Example 1; and

FIG. 15 is a drawing illustrating related information 47 according to Embodiment 1.

### DESCRIPTION OF EMBODIMENTS

### Embodiment 1

### ***Description of Configuration***

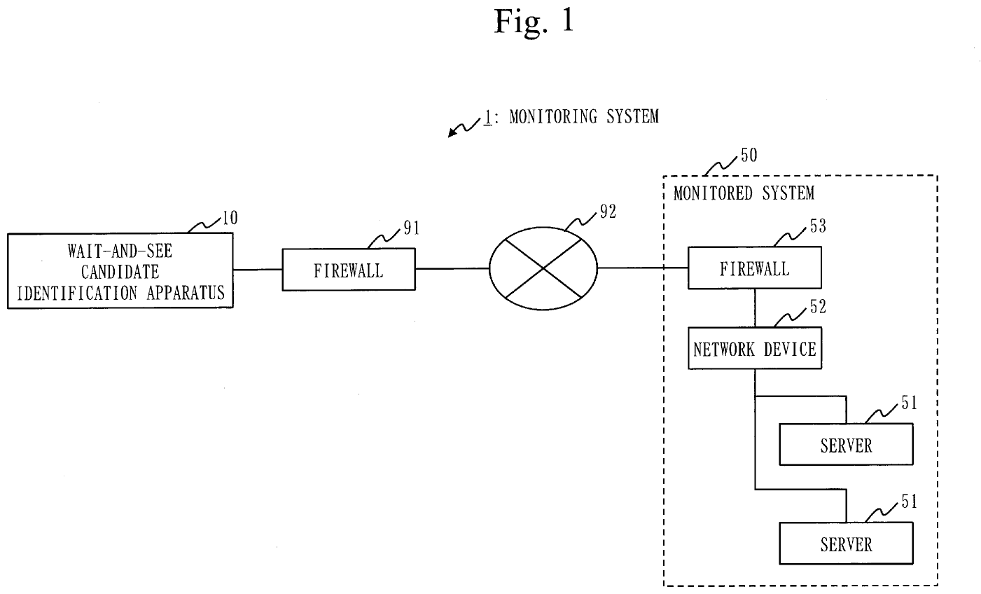

The configuration of a monitoring system 1 according to Embodiment 1 will be described while referencing FIG. 1.

The monitoring system 1 includes a wait-and-see candidate identification apparatus 10 and a monitored system 50. The wait-and-see candidate identification apparatus 10 is connected to the monitored system 50 via a firewall 91 and a network 92.

The monitored system 50 includes one or more servers 51 and one or more network devices 52 as constituents. The network devices 52 are devices such as routers, switches, and hubs. Additionally, the monitored system 50 includes a firewall 53. Here, the monitored system 50 is described as including the server 51 and the network device 52 as constituents. However, the monitored system 50 may include a subsystem including one or more servers 51 and the like as a constituent.

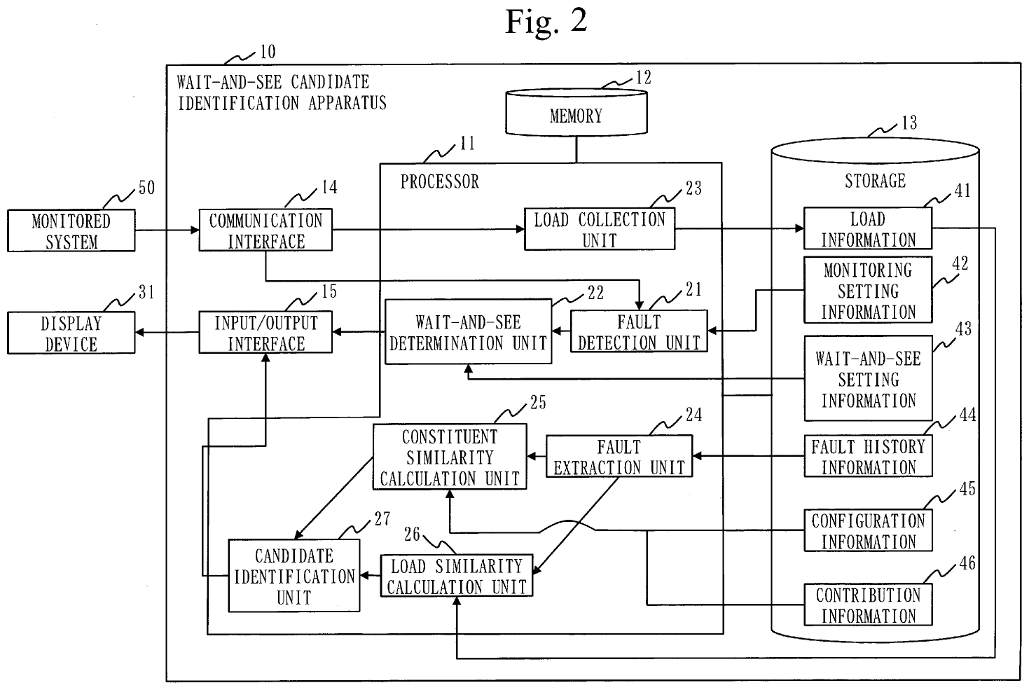

The configuration of the wait-and-see candidate identification apparatus 10 according to Embodiment 1 will be described while referencing FIG. 2.

The wait-and-see candidate identification apparatus 10 is a computer.

The wait-and-see candidate identification apparatus 10 includes hardware, namely a processor 11, a memory 12, a storage 13, a communication interface 14, and an input/output interface 15. The processor 11 is connected to the other hardware via a system bus, and controls the other hardware.

The processor 11 is an integrated circuit (IC) that carries out processing. Specific examples of the processor 11 include a central processing unit (CPU), a digital signal processor (DSP), and a graphics processing unit (GPU).

The memory 12 is working space in which the processor 11 temporarily stores data, information, and programs. Specific examples of the memory 12 include random access memory (RAM).

Specific examples of the storage 13 include read only memory (ROM), flash memory, and a hard disk drive (HDD). Additionally, the storage 13 may be a portable storage medium such as a Secure Digital (SD) memory card, Compact Flash (CF), NAND flash, a floppy disk, an optical disk, a compact disk, a Blu-ray (registered trademark) disk, and a DVD.

The communication interface 14 is a device for communicating with the monitored system 50. Specific examples of the communication interface 14 include Ethernet (registered trademark), RS232C, USB, and IEEE1394 terminals.

The input/output interface 15 is a device for connecting an input device such as a keyboard, a mouse, a microphone, or a camera and a display device 31 such as a display. Specific examples of the input/output interface 15 include digital visual interface (DVI), D-SUB miniature (D-SUB), and high definition multimedia interface (HDMI, registered trademark) terminals.

The wait-and-see candidate identification apparatus 10 includes, as functional constituents, a fault detection unit 21, a wait-and-see determination unit 22, a load collection unit 23, a fault extraction unit 24, a constituent similarity calculation unit 25, a load similarity calculation unit 26, and a candidate identification unit 27. The functions of the various units, namely the fault detection unit 21, the wait-and-see determination unit 22, the load collection unit 23, the fault extraction unit 24, the constituent similarity calculation unit 25, the load similarity calculation unit 26, and the candidate identification unit 27 are realized by software.

A program that realizes the functions of the various units is stored in the storage 13. This program is read into the memory 12 by the processor 11, and executed by the processor 11. Additionally, load information 41, monitoring setting information 42, wait-and-see setting information 43, fault history information 44, configuration information 45, and contribution information 46 are stored in the storage 13.

Information, data, signal values, and variable values that represent the results of the processing of the functions of the various units of the wait-and-see candidate identification apparatus 10 are stored in the memory 12 or in a resistor or cache memory of the processor 11. In the following description, the information, data, signal values, and variable values that represent the results of the processing of the functions of the various units of the wait-and-see candidate identification apparatus 10 are stored in the memory 12.

In FIG. 2, only one processor 11 is illustrated. However, the wait-and-see candidate identification apparatus 10 may include a plurality of processors in place of the processor 11. Responsibility for executing the program to realize the functions of the various units is shared among this plurality of processors. Each individual processor is an IC that carries out processing, the same as the processor 11.

***Description of Operations***

The operations of the wait-and-see candidate identification apparatus 10 according to Embodiment 1 will be described.

The operations of the wait-and-see candidate identification apparatus 10 according to Embodiment 1 correspond to a wait-and-see candidate identification method according to Embodiment 1. Additionally, the operations of the wait-and-see candidate identification apparatus 10 according to Embodiment 1 correspond to the processing of a wait-and-see candidate identification program according to Embodiment 1.

The operations of the wait-and-see candidate identification apparatus 10 according to Embodiment 1 are divided into monitoring processing to monitor the monitored system 50 and update processing to update the wait-and-see setting information 43.

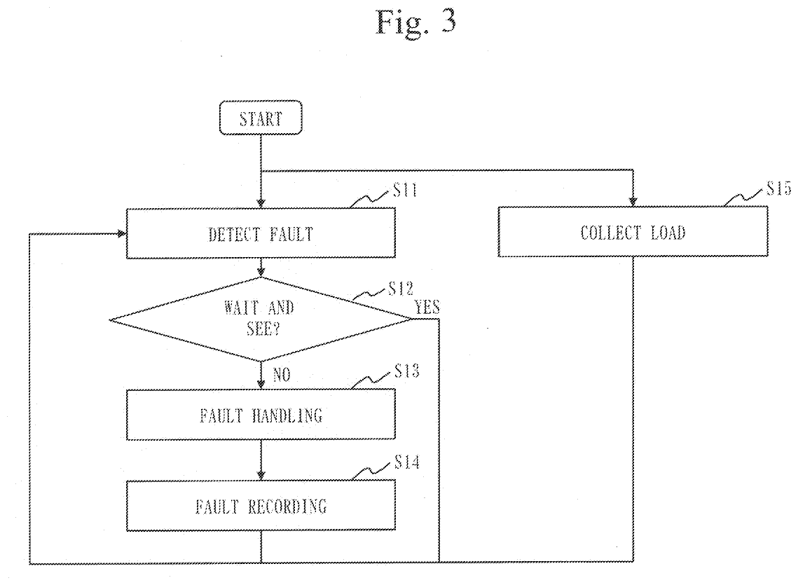

The monitoring processing according to Embodiment 1 will be described while referencing FIG. 3.

(Step S11: Fault Detection Processing)

The fault detection unit 21 collects information from the constituents of the monitored system 50, namely the server 51 and the network device 52 in accordance with the monitoring setting information 42, to detect a fault. When the fault detection unit 21 detects a fault, information indicating the detected fault is transmitted to the wait-and-see determination unit 22 by a method such as interprocess communication. Note that examples of the method to detect faults include a method in which agent software is installed in the various devices of the monitored system 50, a method in which monitoring is performed over the network without agents, and a method in which a monitoring-dedicated device is disposed in the monitored system 50 and fault information is obtained from that device.

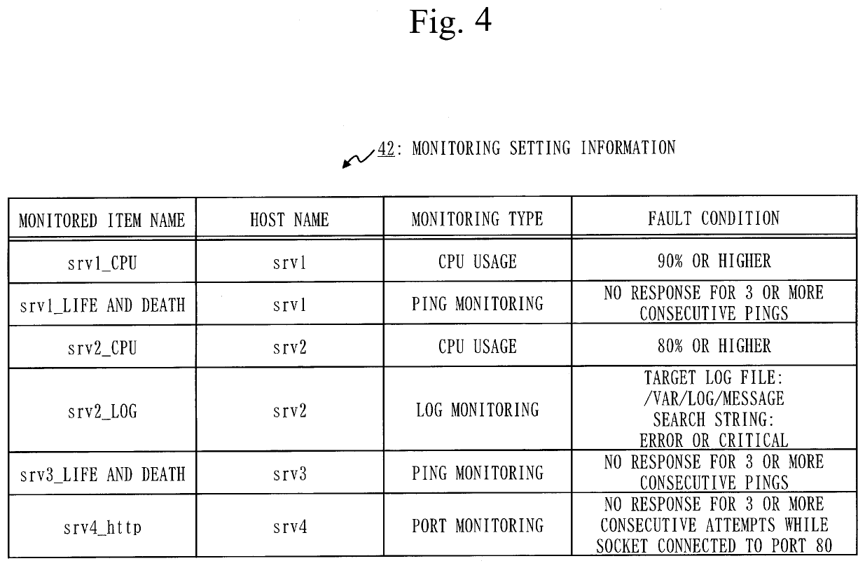

As illustrated in FIG. 4, the monitoring setting information 42 is information that indicates what kind of monitoring to perform on the constituents of the monitored system 50, namely the server 51 and the network device 52, and what kind of conditions to consider as faults. In FIG. 4, the monitoring setting information 42 includes a host name, a monitoring type, and a fault condition for each monitored item name. The monitored item name is an identifier of the fault. The host name is an identifier of the constituent, namely the device, of the monitored system 50. The monitoring type is an identifier of the type of fault. The fault condition is the condition under which a fault is determined.

In one specific example, for a specific server 51, the monitoring setting information 42 indicates such conditions as if the CPU usage is a certain percentage or higher and if there have been a certain number or more of consecutive PINGs without responses. Additionally, in one specific example, for a specific network device 52, the monitoring setting information 42 indicates such conditions as if the network usage is a certain percentage or higher and if there have been a certain number or more of lost packets.

In one specific example, when the monitoring setting information 42 is the content illustrated in FIG. 4, the fault detection unit 21 acquires the CPU usage and the PING response information for the server 51 called srv1. Then, in cases in which the CPU usage is 90% or higher and in cases in which there have been three or more continuous PINGs without responses, the fault detection unit 21 detects a match with the fault condition and detects that a fault has occurred in the server 51 called srv1. In cases in which the CPU usage is 90% or higher, the fault detection unit 21 transmits the monitored item name called srv1 CPU to the wait-and-see determination unit 22 as information indicating a detected fault.

(Step S12: Wait-and-See Determination Processing)

The wait-and-see determination unit 22 references the wait-and-see setting information 43 to determine whether to wait and seen with respect to the fault indicated in the information transmitted from the fault detection unit 21 in step S11.

When the wait-and-see determination unit 22 determines to wait and see, the processing advances to step S13, and when the wait-and-see determination unit 22 determines not to wait and see, the processing returns to step S11.

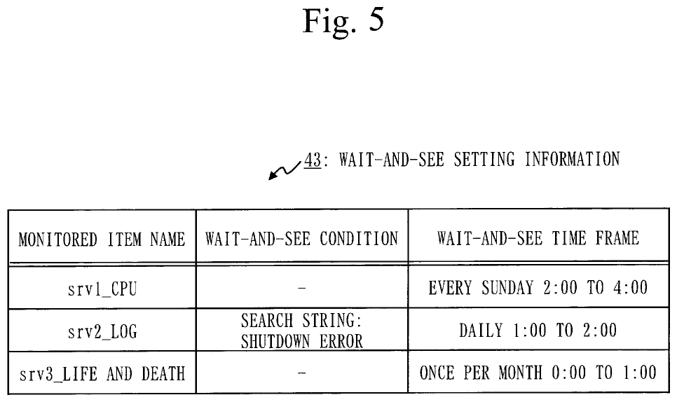

As illustrated in FIG. 5, the wait-and-see setting information 43 is information for identifying faults designated as requiring no handling. In FIG. 5, the wait-and-see setting information 43 includes a wait-and-see condition and a wait-and-see time frame for each monitored item name. The wait-and-see condition is the condition for adopting the wait-and-see handling. The wait-and-see time frame is the time frame to adopt the wait-and-see handling. When the wait-and-see condition and the wait-and-see time frame are both set, the wait-and-see handling is adopted if both are satisfied.

In one specific example, for the specific server 51, the wait-and-see setting information 43 indicates that no handling is required for states where the CPU usage is high during a certain time frame. This means that even though the CPU usage is higher in a time frame during which regularly executed batch processing is performed than in other time frames, it is not abnormal and thus no handling is required. Other than the CPU usage, it may be considered that even if a shutdown error log is output during a certain time frame in order to perform regular reboot processing, this is not abnormal and thus no handling is required; and even if there are no PING responses during regular rebooting, this is not abnormal and thus no handling is required.

In one specific example, in a case in which the wait-and-see setting information 43 is the content illustrated in FIG. 5, when the monitored item name called srv1_CPU is transmitted, if the time of occurrence is from 2:00 to 4:00 on Sunday, the wait-and-see determination unit 22 determines to wait and see, and if a different time, determines not to wait and see.

(Step S13: Fault Handling Processing)

The wait-and-see determination unit 22 sends the information indicating the fault detected in step S11 to the display device 31 via the input/output interface 15 and displays the information on the display device 31. As a result, the wait-and-see determination unit 22 transmits the detected fault to an administrator.

In one specific example, in a case in which the CPU usage is 90% or higher, the wait-and-see determination unit 22 displays, on the display device 31, the monitored item name called srv1_CPU as the information indicating the fault detected by the fault detection unit 21. At this time, the wait-and-see determination unit 22 may also perform other notifications such as emitting sound from a speaker or causing a lamp to light up.

(Step S14: Fault Recording Processing)

The wait-and-see determination unit 22 writes the information indicating the fault detected in step S11 as the fault history information 44 to the storage 13. Additionally, content of handling executed by the administrator for the fault detected in step S11 is written as the fault history information 44 to the storage 13.

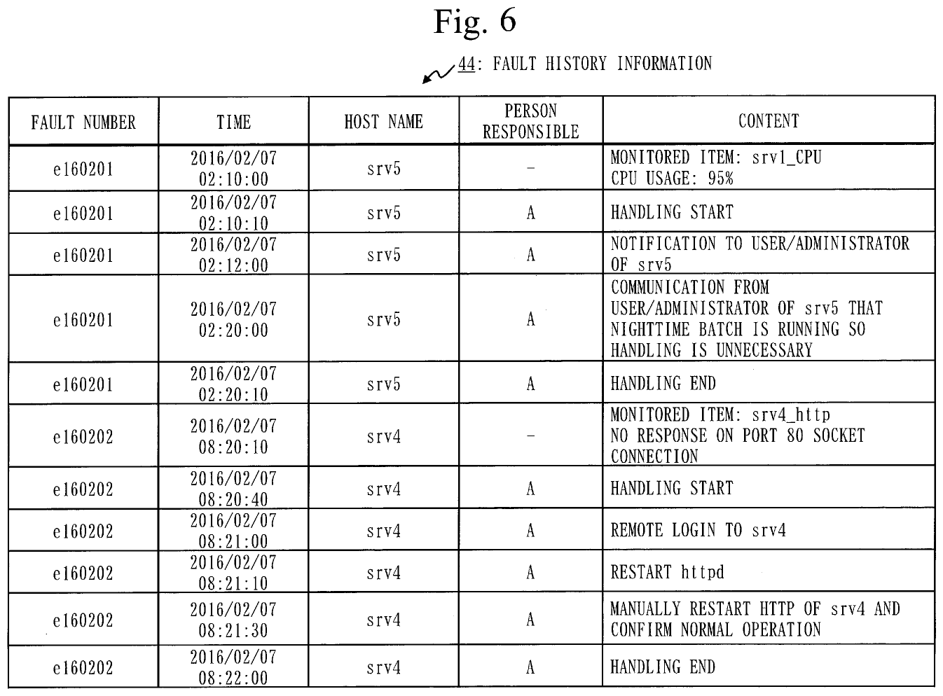

As illustrated in FIG. 6, the fault history information 44 is information indicating the content of the detected fault and the content of handling executed by the administrator for that fault. In FIG. 6 the fault history information 44 includes a host name, a person responsible, and content for each fault number and time. The fault number is an identifier of the detected fault. The time is the time at which the record was written. The host name is an identifier of the constituent, namely the device, of the monitored system 50. The person responsible is an identifier of the administrator who handled the fault. The content is the content of the fault or the content of executed handling. In the fault history information 44, the content of executed handling can be chronologically confirmed from the content of the detected fault by confirming, in order of time, the contents of the records identified by a single fault number.

(Step S15: Load Collection Processing)

The load collection unit 23 regularly collects information related to the loads of the various constituents of the monitored system 50 independent from step S11 to step S14, and writes this information as the load information 41 to the storage 13. The load collection unit 23 collects the information related to the loads at prescribed intervals for a variety of prescribed ranges such as by system, by host, and by item.

Note that examples of methods to acquire the load information include a method in which agent software is installed in the various devices of the monitored system 50, and a method in which the load information is collected by a standardized protocol such as simple network management protocol (SNMP).

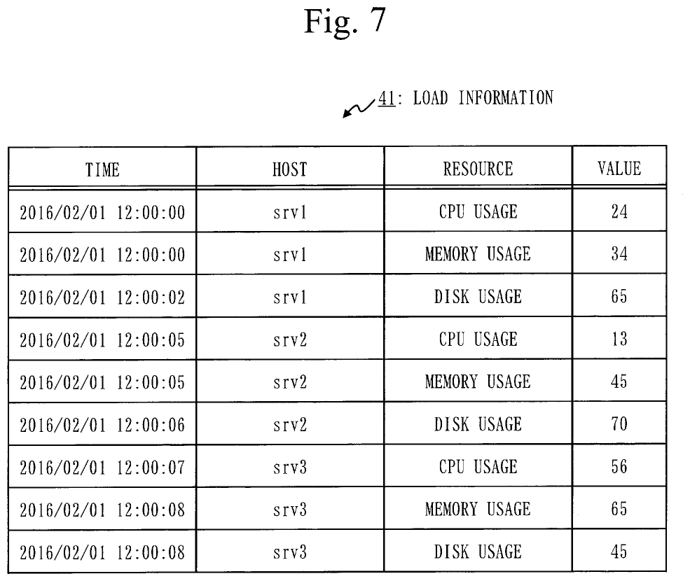

As illustrated in FIG. 7, the load information 41 is information indicating, for each time, the loads of the various constituents of the monitored system 50. In FIG. 7 the load information 41 includes a resource and a value for each time and host name. The resource is an identifier indicating the subject of the load of the constituent. The value is a value representing the load.

When the constituent is the server 51, the load information 41 indicates CPU usage, memory usage, storage disk usage, and the like for each time. When the constituent is the network device 52, the load information 41 indicates network usage, the number of lost packets, and the like for each time.

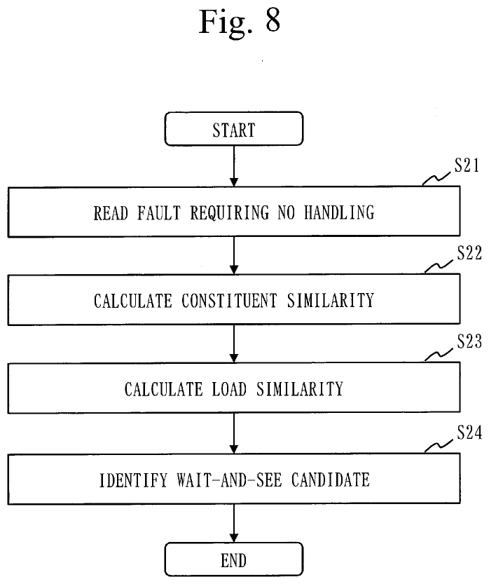

The update processing according to Embodiment 1 will be described while referencing FIG. 8.

(Step S21: Fault Extraction Processing)

The fault extraction unit 24 reads, from the storage 13, the fault history information 44 of the faults requiring no handling. In a specific example, the fault extraction unit 24 searches for a character string indicating that no handling is required from the content fields of the fault history information 44, and reads the records of the hit fault history information 44.

The fault extraction unit 24 extracts, as wait-and-see subjects, faults that satisfy a criterion from the read fault history information 44. Specific examples of the criterion include faults for which the constituent is the same and also for which there are a certain number or more of the fault number with the same fault content. The processing to extract as wait-and-see subjects may be manually executed separately by the administrator.

The fault extraction unit 24 writes the information of the extracted wait-and-see subjects as the wait-and-see setting information 43 to the storage 13. As a result, thereafter, when a fault that is the same as the faults that were extracted as the wait-and-see subjects occurs, wait-and-see will be determined to be performed in step S12.

(Step S22: Constituent Similarity Calculation Processing)

The constituent similarity calculation unit 25 sets, as a comparison source element, the constituent to be processed among the wait-and-see subjects extracted in step S21, that is, the constituent of the monitored system 50 in which a fault requiring no handling has occurred among faults that have occurred in the monitored system 50. Additionally, the constituent similarity calculation unit 25 sequentially sets the other various constituents of the monitored system 50 as comparison target elements.

Then, the constituent similarity calculation unit 25 determines whether the comparison source element and the comparison target elements match for each attribute. The constituent similarity calculation unit 25 calculates configuration similarities for the comparison target elements on the basis of the attributes determined to match and a contribution assigned to each attribute.

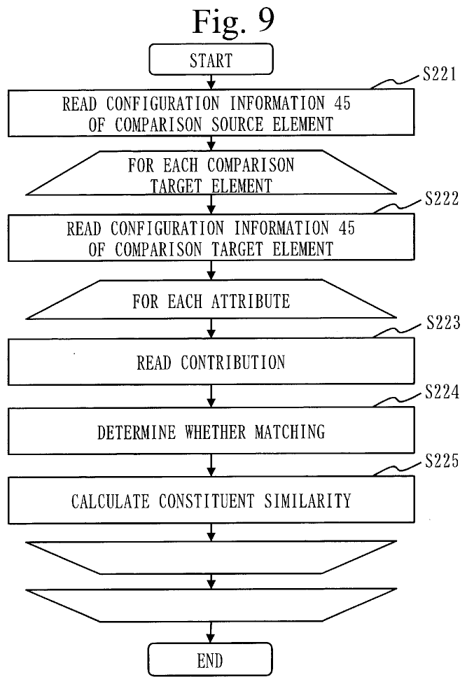

The constituent similarity calculation processing of step S22 according to Embodiment 1 will be described while referencing FIG. 9.

(Step S221: Source Information Reading Processing)

The constituent similarity calculation unit 25 acquires the identifier, namely the host name, of the constituent to be set as the subject among the wait-and-see subjects extracted in step S21, and sets the constituent indicated by the acquired host name as the comparison source element. The constituent similarity calculation unit 25 reads the configuration information 45 of the comparison source element from the storage 13.

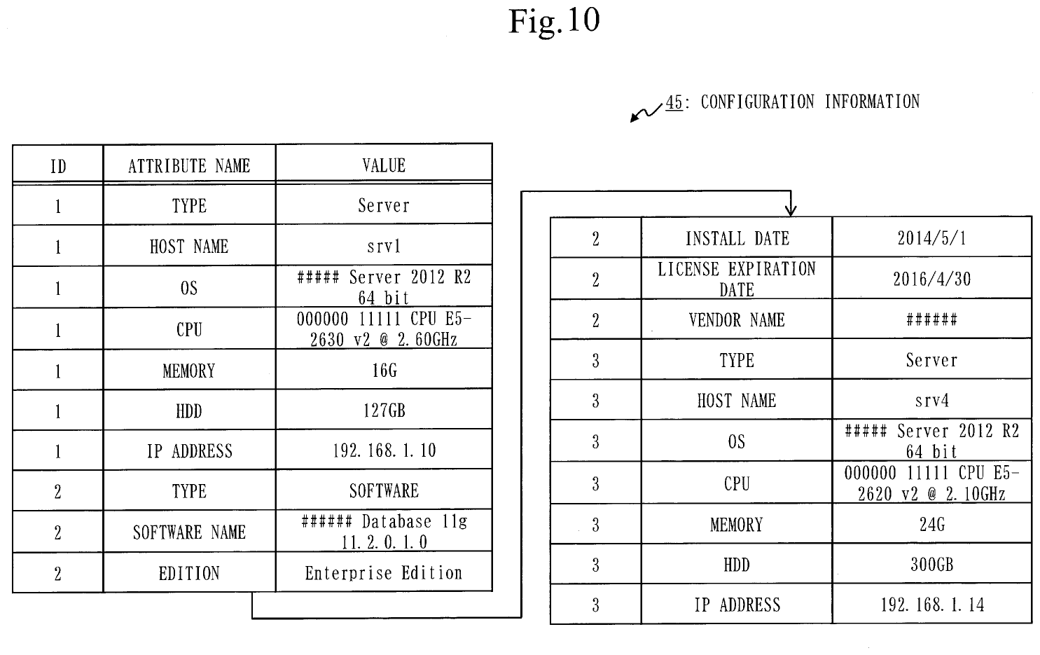

As illustrated in FIG. 10, the configuration information 45 is information about the various constituents of the monitored system 50. In FIG. 10, the configuration information 45 includes a value for each ID and attribute name. The IDs are identifiers that uniquely identify all of the constituents such as the devices and the software. The IDs differ from the host names in that, while the host names are identifiers for the devices among the constituents, the IDs are identifiers for all of the constituents. The attribute name is an identifier of the attribute. The value is an attribute value. Accordingly, in FIG. 10, information about one constituent is expressed by a plurality of records of a single ID.

The values of records for which the attribute name is “type” represent the type of that constituent, and the content set for the attribute name depends on the type. In one specific example, when the type is “server”, a host name, an OS, a CPU, a memory, a HDD, and an IP address are set as attribute names. Additionally, when the type is “software”, a software name, an edition, an install date, a license expiration date, and a vendor name are set as attribute names.

Next, the constituent similarity calculation unit 25 sets, as the comparison target elements, constituents for which the type is the same as the comparison source element, and executes the processing of step S222 to step S225 for each comparison target element.

(Step S222: Target Information Reading Processing)

The constituent similarity calculation unit 25 reads the configuration information 45 of the comparison target element being processed from the storage 13.

Next, the constituent similarity calculation unit 25 executes the processing of step S223 to step S224 for each attribute of the comparison source element.

(Step S223: Contribution Reading Processing)

The constituent similarity calculation unit 25 reads the contribution included in the contribution information 46 from the storage 13 for the type and the attributes of the comparison source element. At this time, the constituent similarity calculation unit 25 reads the contribution of the records, in the contribution information 46, having a comparison parameter that matches the value of the attribute of the comparison source element.

Note that, when there are multiple records having a comparison parameter that matches the value of the attribute of the comparison source element, the constituent similarity calculation unit 25 reads the lowest contribution. In contrast, when there are no records having a comparison parameter that matches the value of the attribute of the comparison source element, the contribution is set to a fixed value. In a specific example, the fixed value is 1.0.

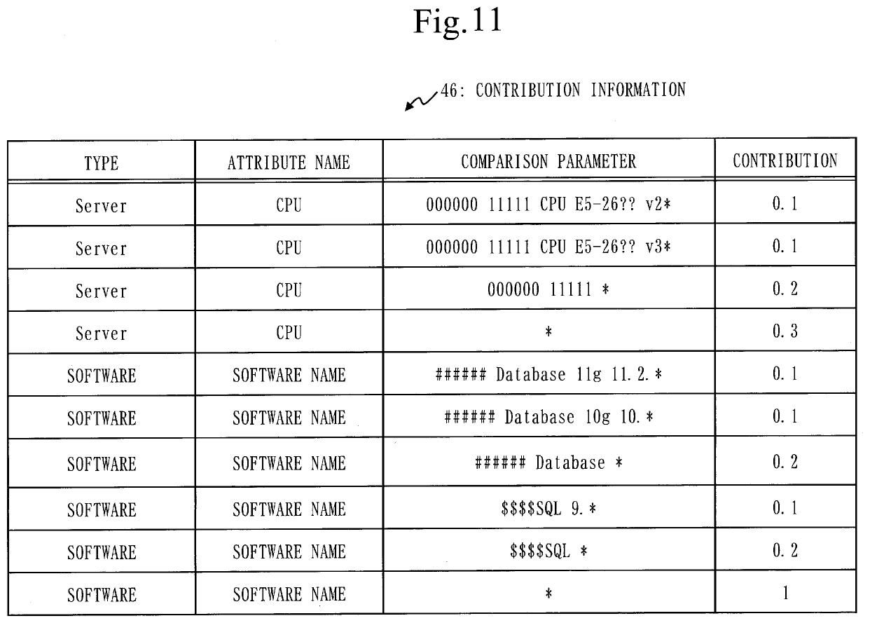

As illustrated in FIG. 11, the contribution information 46 is information for calculating the similarity for each attribute. In FIG. 11, the contribution information 46 includes a comparison parameter and a contribution for each type and attribute. The comparison parameter is a parameter to be compared against the value of the configuration information 45 of the comparison source element. In FIG. 11, in the comparison parameters, “?” matches any single character, and “*” matches zero or more arbitrary characters. The contribution is a coefficient used when calculating the similarity.

In a specific example, the CPU of host name srv1 illustrated in FIG. 10 matches the comparison parameter of the records of lines 1 to 4 of FIG. 11. As such, the lowest contribution of the contributions of the records of lines 1 to 4, namely 0.1, is read.

(Step S224: Match Determination Processing)

The constituent similarity calculation unit 25 determines whether values match for each attribute for the comparison source element and the comparison target element being processed.

(Step S225: Similarity Calculation Processing)

The constituent similarity calculation unit 25 calculates the configuration similarity of the comparison target element using the contribution of the record read in step S223 for the attributes determined to have matching values in step S224.

Specifically, in Embodiment 1, the constituent similarity calculation unit 25 uses the Dice coefficient to calculate, as the configuration similarity, a value obtained by dividing a number of common elements, for which the values of the attribute of the comparison source element and the attribute of the comparison target element match, by an average value of the number of attributes of the comparison source element and the number of attributes of the comparison target element. Note that when counting the numbers of attributes, the numbers of attributes themselves are not counted but, rather, the values of the contributions of the various attributes are summed. The closer the attribute similarity is to 1, the more similar the comparison source element and the comparison target element are to each other, and the closer the attribute similarity is to 0, the less similar the comparison source element and the comparison target element are with each other.

Note that, in addition to the Dice coefficient, any technique for calculating the similarity between two sets, such as the Jaccard coefficient and the Simpson coefficient, may be used.

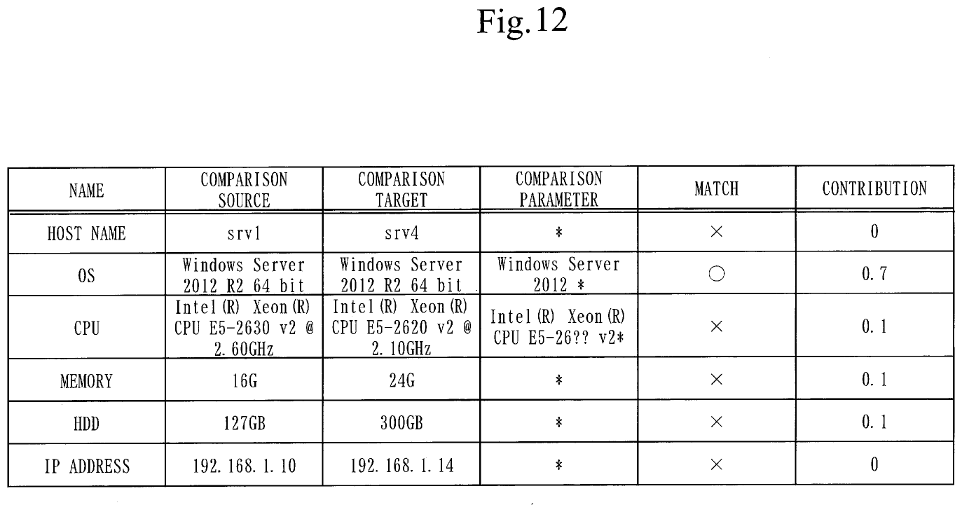

A specific example will be described with reference to FIG. 12. In FIG. 12, a case is illustrated in which the constituent for which the host name is srv1 and the constituent for which the host name is srv4 are compared.

In FIG. 12, one attribute matches, namely the OS, but since the contribution is 0.7, the number of common elements is 0.7. Additionally, the number of attributes of the comparison source element is 6, namely the host name, the OS, the CPU, the memory, the HDD, and the IP address, but when summed using the respective contributions, is 1.0. Likewise, the number of attributes of the comparison target element is 1.0. Accordingly, the average value of the numbers of attributes is 1.0. Thus, the configuration similarity is 0.7/1.0, or 0.7.

Note that in a case in which the configuration similarity is calculated without using the contribution, one attribute matches, namely the OS, and the average value of the number of attributes is 6 and, as such, the configuration similarity becomes ⅙ or 0.167. Thus, by using the contribution, the influence of items that do not impart significant differences, such as the model number of the CPU and the amount of memory, can be reduced.

(Step S23: Load Similarity Calculation Processing)

The load similarity calculation unit 26 sets, as the comparison source element, the constituent to be set as the subject among the wait-and-see subjects extracted in step S21, that is, the constituent of the monitored system 50 in which a fault requiring no handling has occurred among faults that have occurred in the monitored system 50. Additionally, the load similarity calculation unit 26 sequentially sets the other various constituents of the monitored system 50 as comparison target elements.

Then, the load similarity calculation unit 26 calculates, as the load similarities of the comparison target elements, degrees of similarity of the loads of the comparison source element and the comparison target elements.

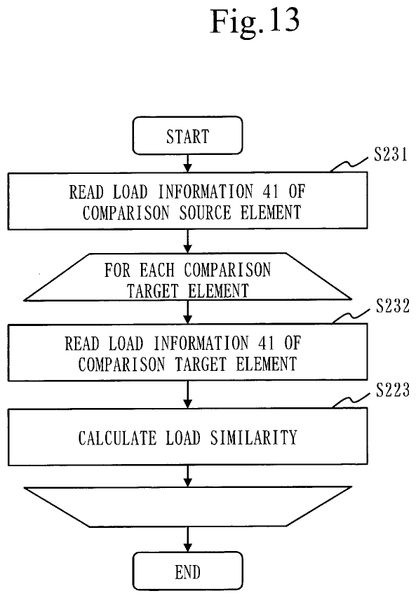

The load similarity calculation processing of step S23 according to Embodiment 1 will be described while referencing FIG. 13.

(Step S231: Source Information Reading Processing)

The load similarity calculation unit 26 acquires the identifier, namely the host name, of the constituent to be set as the subject among the wait-and-see subjects extracted in step S21, and sets the constituent indicated by the acquired host name as the comparison source element. The constituent similarity calculation unit 25 reads the load information 41 of the comparison source element from the storage 13.

Next, the load similarity calculation unit 26 sets constituents for which the type is the same as the comparison source element as the comparison target elements, and executes the processing of step S232 to step S233 for each comparison target element.

(Step S232: Target Information Reading Processing)

The load similarity calculation unit 26 reads the load information 41 of the comparison target element being processed from the storage 13.

(Step S233: Similarity Calculation Processing)

The load similarity calculation unit 26 calculates the similarity between the load information 41 of the comparison source element read in step S231 and the load information 41 of the comparison target elements read in step S232.

Specifically, in Embodiment 1, the load similarity calculation unit 26 calculates an average value of the load in a given time period, and sets the closeness of the calculated average value as the similarity for each corresponding load information 41. Then, the load similarity calculation unit 26 sums the similarities calculated for each load information 41 to calculate the load similarity. Specifically, the load similarity calculation unit 26 calculates, as similarities, the closenesses of the load for each of the CPU usage, the memory usage, and the disk usage, and sums the calculated similarities to obtain the load similarity.

Additionally, the load similarity calculation unit 26 may use linear interpolation or curve interpolation to calculate approximate expressions such as polynomial or trigonometric functions that express changes in the loads, and compare the calculated approximate expressions to calculate, as the similarities, the closenesses of the loads that change with time. In this case, to enable comparison, approximate expressions of the same form are used for the comparison source element and the comparison target elements. Then, the load similarity calculation unit 26 may sum the similarities calculated for each load information 41 to calculate the load similarity.

In addition, the load similarity calculation unit 26 may calculate the load similarity by a combination of resource usages. Specifically, the closeness of a value obtained by dividing an average value of the CPU usage in the given period of time by an average value of the memory usage in a given period of time may be calculated as the load similarity. Additionally, the load similarity may be calculated using a parameter of an autoregressive moving average model. Moreover, the load similarity may be calculated by combining a number of the load similarity calculation methods described above.

(Step S24: Candidate Identification Processing)

The candidate identification unit 27 weights and sums the configuration similarity calculated in step S22 and the load similarity calculated in step S23 to calculate an overall similarity. Then, the candidate identification unit 27 identifies the comparison target elements for which the calculated overall similarity is high as wait-and-see candidates.

The candidate identification unit 27 displays the identified wait-and-see candidates on the display device 31 via the input/output interface 15, and presents the wait-and-see candidates to the administrator of the monitored system 50. At this time, the candidate identification unit 27 may display the overall similarity, the configuration similarity, and the load similarity for the wait-and-see candidates together with the wait-and-see candidates.

Note that, similar to the information about the comparison source element being written to the storage 13 as the wait-and-see setting information 43 in step S21, the information about the wait-and-see candidate identified in step S24 may also be written to the storage 13 as the wait-and-see setting information 43. Alternatively, a configuration is possible in which, of the wait-and-see candidates identified in step S24, only information about the wait-and-see candidates selected by the administrator is written in the storage 13 as the wait-and-see setting information 43.

### Advantageous Effects of Embodiment 1

As described above, the wait-and-see candidate identification apparatus 10 according to Embodiment 1 determines the configuration similarity between constituents while considering the contributions of the constituents. Additionally, the wait-and-see candidate identification apparatus 10 according to Embodiment 1 does not only determine the configuration similarity between the constituents, but also determines the overall similarity between the constituents while considering the load similarity. Therefore, the similarity between the constituents can be appropriately determined. As a result, the wait-and-see candidates can be appropriately identified.

As a specific example, in a case of a CPU, which is one constituent of a server, even if there is not a significant difference between CPUs except for a difference in clock frequency, the model numbers are different when the CPUs are compared. As a result, such CPUs have been conventionally regarded as different products. Meanwhile, even if pieces of software have similar functions, there are differences in functions, vulnerability, and unknown and known bugs when the vendors are different, which results in significant differences when faults occur. However, conventionally, such pieces of software have been determined to be similar. In contrast, with the wait-and-see candidate identification apparatus 10 according to Embodiment 1, the configuration similarity is determined while considering the contribution, and the overall similarity is determined while considering the load similarity and, as a result, the similarity can be appropriately determined.

***Other Configurations***

### Modification Example 1

In Embodiment 1, the functions of the various units of the wait-and-see candidate identification apparatus 10 are realized by software. Alternatively, in Modification Example 1, the functions of the respective units of the wait-and-see candidate identification apparatus 10 may be realized by hardware. The differences between Modification Example 1 and Embodiment 1 shall be described.

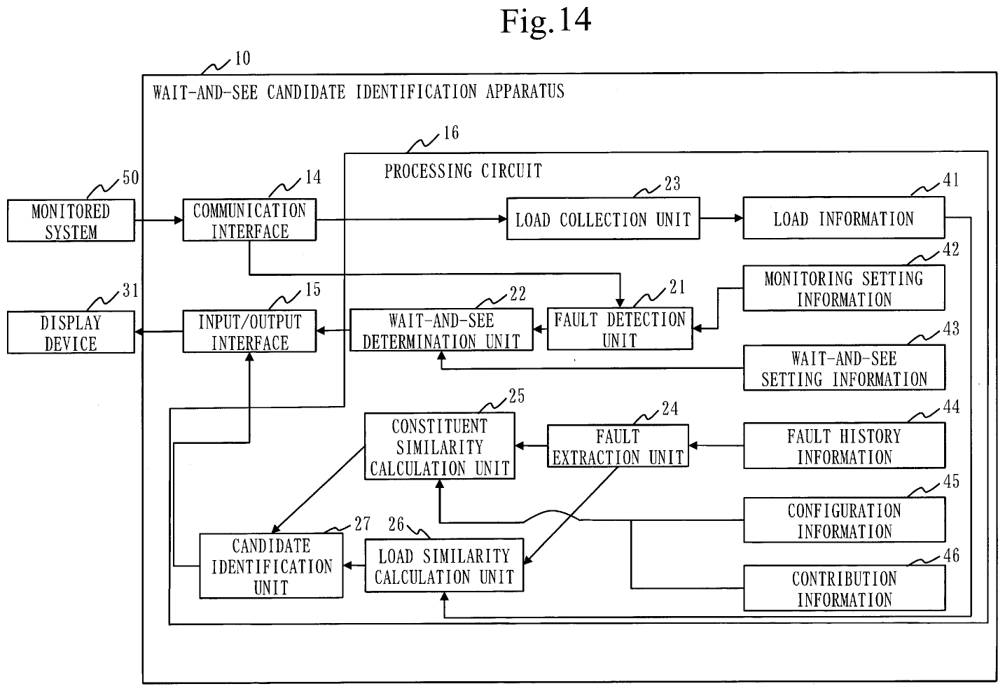

The configuration of the wait-and-see candidate identification apparatus 10 according to Modification Example 1 will be described while referencing FIG. 14. When the functions of the various units are realized by hardware, the wait-and-see candidate identification apparatus 10 includes a processing circuit 16 in place of the processor 11, the memory 12, and the storage 13. The processing circuit 16 is a dedicated electronic circuit that realizes the functions of the various units of the wait-and-see candidate identification apparatus 10 and the functions of the memory 12 and the storage 13.

The processing circuit 16 is envisioned as a single circuit, a composite circuit, a programmed processor, a parallel programmed processor, a logic IC, a Gate Array (GA), an Application Specific Integrated Circuit (ASIC), or a Field-Programmable Gate Array (FPGA).

The wait-and-see candidate identification apparatus 10 may include a plurality of processing circuits in place of the processing circuit 16. The functions of the various units are realized in whole by this plurality of processing circuits. As with the processing circuit 16, each of the processing circuits is a dedicated electronic circuit.

### Modification Example 2

In Modification Example 2, a portion of the functions may be realized by hardware, and the remaining functions may be realized by software. That is, a portion of the functions of the various units of the wait-and-see candidate identification apparatus 10 may be realized by hardware, and the remaining functions may be realized by software.

The processor 11, the memory 12, the storage 13, and the processing circuit 16 are collectively referred to as “processing circuitry.” That is, the functions of the various units are realized by the processing circuitry.

### Modification Example 3

Commercially available tools such as server monitoring and network monitoring may be used for the fault detection unit 21, the wait-and-see determination unit 22, and the load collection unit 23.

### Embodiment 2

Embodiment 2 differs from Embodiment 1 in that, in Embodiment 2, the configuration similarity is calculated while also considering a related element that is a constituent related to the comparison source element and a related element that is a constituent related to the comparison target element. In Embodiment 2, the differences are described.

***Description of Operations***

The processing of step S22 of FIG. 8 differs from Embodiment 1.

The constituent similarity calculation processing of step S22 according to Embodiment 2 will be described while referencing FIG. 9.

(Step S221: Source Information Reading Processing)

As in Embodiment 1, the constituent similarity calculation unit 25 acquires the identifier, namely the host name, of the constituent to be set as the subject among the wait-and-see subjects extracted in step S21, and sets the constituent with the acquired host name as the comparison source element. The constituent similarity calculation unit 25 reads the configuration information 45 of the comparison source element from the storage 13.

Additionally, the constituent similarity calculation unit 25 references related information 47 included in the configuration information 45 to identify the related element that is a constituent related to the comparison source element, and reads the configuration information 45 of the identified related element from the storage 13.

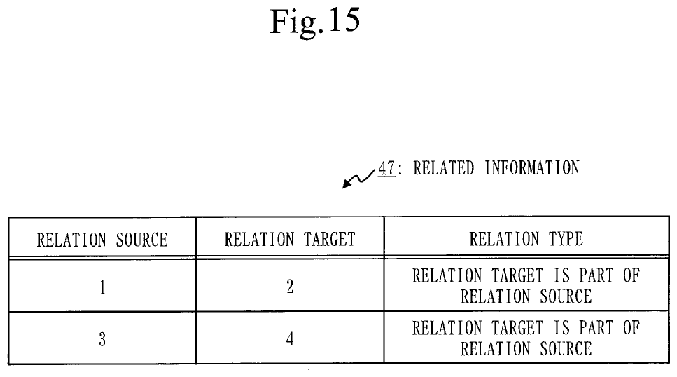

As illustrated in FIG. 15, the related information 47 is information indicating the relationships between the constituents. In FIG. 15, the related information 47 has a relation target and a relation type for each relation source. The relation source is the ID of the constituent used as the relation source. The relation target is the ID of the constituent related to the relation source. The relation type is information indicating the relationship between the relation source and the relation target. In a specific example, the relation type indicates that the relation target is a part of the relation source, the relation target is dependent on the relation source, the relation target belongs to the relation source, or that a multiplexing relationship exists. Additionally, the relation type may include information such as the time/date the relationship was established and the person responsible for establishing the relationship.

The constituent similarity calculation unit 25 can identify the constituent of the relation target by searching for the ID of the comparison source element from the relation source of the related information 47 and reading the ID of the relation target.

(Step S222: Target Information Reading Processing)

The constituent similarity calculation unit 25 reads the configuration information 45 of the comparison target element being processed from the storage 13. Additionally, the constituent similarity calculation unit 25 references the related information 47 to identify the related element that is a constituent related to the comparison target element being processed, and reads the configuration information 45 of the identified related element from the storage 13.

(Step S223: Contribution Reading Processing)

As in Embodiment 1, the constituent similarity calculation unit 25 reads the contribution included in the contribution information 46 from the storage 13 for the type and the attributes of the comparison source element. Additionally, the constituent similarity calculation unit 25 reads the contribution included in the contribution information 46 from the storage 13 for the type and the attributes of the related element related to the comparison source element identified in step S221.

(Step S224: Match Determination Processing)

As in Embodiment 1, the constituent similarity calculation unit 25 determines whether values match for each attribute for the comparison source element and the comparison target element being processed. Additionally, the constituent similarity calculation unit 25 determines whether values match for each attribute for the related element related to the comparison source element identified in step S221 and the related element related to the comparison target element identified in step S222.

(Step S225: Similarity Calculation Processing)

The constituent similarity calculation unit 25 calculates, for the attributes determined to match in step S224, the configuration similarity for the comparison target element using the contribution of the record read in step S223.

### Advantageous Effects of Embodiment 2

As described above, the wait-and-see candidate identification apparatus 10 according to Embodiment 2 calculates the configuration similarity while also considering the related element that is a constituent related to the comparison source element and the related element that is a constituent related to the comparison target element. Therefore, the similarity between the constituents can be more appropriately determined.

### REFERENCE SIGNS LIST

10: wait-and-see candidate identification apparatus, 11: processor, 12: memory, 13: storage, 14: communication interface, 15: input/output interface, 16: processing circuit, 21: fault detection unit, 22: wait-and-see determination unit, 23: load collection unit, 24: fault extraction unit, 25: constituent similarity calculation unit, 26: load similarity calculation unit, 27: candidate identification unit, 31: display device, 41: load information, 42: monitoring setting information, 43: wait-and-see setting information, 44: fault history information, 45: configuration information, 46: contribution information, 47: related information, 50: monitored system.

1.-7. (canceled)

8. A wait-and-see candidate identification apparatus, comprising:
processing circuitry to:
determine, for each attribute, whether a comparison source element that is a constituent of a monitored system in which a subject fault occurred and a comparison target element that is another constituent of the monitored system match, the subject fault being a fault requiring no handling among faults that have occurred in the monitored system, and calculate a configuration similarity for the comparison target element using the attributes determined to match and a contribution assigned to each of the attributes; and
identify, on a basis of the calculated configuration similarity, a wait-and-see candidate that is a candidate of a constituent requiring no handling when the subject fault has occurred.

9. The wait-and-see candidate identification apparatus according to claim 8,
wherein the processing circuitry determines, for each attribute, whether a related element that is a constituent related to the comparison source element and a related element that is a constituent related to the comparison target element match, and calculates the configuration similarity using the attributes determined to match and a contribution assigned to each of the attributes.

10. The wait-and-see candidate identification apparatus according to claim 8,
wherein the processing circuitry calculates the configuration similarity by dividing a total value of the contributions assigned to each of the attributes determined to match by an average value of a total value of the contributions assigned to each of the attributes of the comparison source element and a total value of the contributions assigned to each of the attributes of the comparison target element.

11. The wait-and-see candidate identification apparatus according to claim 9,
wherein the processing circuitry calculates the configuration similarity by dividing a total value of the contributions assigned to each of the attributes determined to match by an average value of a total value of the contributions assigned to each of the attributes of the comparison source element and a total value of the contributions assigned to each of the attributes of the comparison target element.

12. The wait-and-see candidate identification apparatus according to claim 8,
wherein the processing circuitry calculates a load similarity between a load of the comparison source element and a load of the comparison target element when the subject fault has occurred, and
identifies the wait-and-see candidate on a basis of the configuration similarity and the calculated load similarity.

13. The wait-and-see candidate identification apparatus according to claim 9,
wherein the processing circuitry calculates a load similarity between a load of the comparison source element and a load of the comparison target element when the subject fault has occurred, and
identifies the wait-and-see candidate on a basis of the configuration similarity and the calculated load similarity.

14. The wait-and-see candidate identification apparatus according to claim 10,
wherein the processing circuitry calculates a load similarity between a load of the comparison source element and a load of the comparison target element when the subject fault has occurred, and
identifies the wait-and-see candidate on a basis of the configuration similarity and the calculated load similarity.

15. The wait-and-see candidate identification apparatus according to claim 11,
wherein the processing circuitry calculates a load similarity between a load of the comparison source element and a load of the comparison target element when the subject fault has occurred, and
identifies the wait-and-see candidate on a basis of the configuration similarity and the calculated load similarity.

16. The wait-and-see candidate identification apparatus according to claim 12,
wherein the processing circuitry calculates an overall similarity by weighting and summing the configuration similarity and the load similarity, and identifies the comparison target element for which the calculated overall similarity is high as the wait-and-see candidate.

17. The wait-and-see candidate identification apparatus according to claim 13,
wherein the processing circuitry calculates an overall similarity by weighting and summing the configuration similarity and the load similarity, and identifies the comparison target element for which the calculated overall similarity is high as the wait-and-see candidate.

18. The wait-and-see candidate identification apparatus according to claim 14,
wherein the processing circuitry calculates an overall similarity by weighting and summing the configuration similarity and the load similarity, and identifies the comparison target element for which the calculated overall similarity is high as the wait-and-see candidate.

19. The wait-and-see candidate identification apparatus according to claim 15,
wherein the processing circuitry calculates an overall similarity by weighting and summing the configuration similarity and the load similarity, and identifies the comparison target element for which the calculated overall similarity is high as the wait-and-see candidate.

20. A wait-and-see candidate identification method, comprising:
determining, for each attribute, whether a comparison source element that is a constituent of a monitored system in which a subject fault occurred and a comparison target element that is another constituent of the monitored system match, the subject fault being a fault requiring no handling among faults that have occurred in the monitored system, and calculating a configuration similarity for the comparison target element using the attributes determined to match and a contribution assigned to each of the attributes; and
identifying, on a basis of the configuration similarity, a wait-and-see candidate that is a candidate of a constituent requiring no handling when the subject fault has occurred.

21. A non-transitory computer readable medium storing a wait-and-see candidate identification program that causes a computer to execute:
constituent similarity calculation processing to determine, for each attribute, whether a comparison source element that is a constituent of a monitored system in which a subject fault occurred and a comparison target element that is another constituent of the monitored system match, the subject fault being a fault requiring no handling among faults that have occurred in the monitored system, and calculate a configuration similarity for the comparison target element using the attributes determined to match and a contribution assigned to each of the attributes; and
candidate identification processing to identify, on a basis of the configuration similarity calculated by the constituent similarity calculation processing, a wait-and-see candidate that is a candidate of a constituent requiring no handling when the subject fault has occurred.
